(19) United States
(12) Patent Application Publication
(10) Pub. No.: US 2026/0349920 A1
(43) Pub. Date: Nov. 5, 2026

(54) REDUCING MEMORY BANK CONFLICTS IN A HARDWARE ACCELERATOR

(71) Applicant: Google LLC, Mountain View, CA (US)

(72) Inventor: Andrey Ayupov, Mountain View, CA (US)

(21) Appl. No.: 19/111,853

(22) PCT Filed: Sep. 15, 2022
(86) PCT No.: PCT/US2022/076500

§ 371 Date: Mar. 14, 2025

(51) Int. Cl. G06F 12/06

(52) U.S. Cl. CPC G06F 12/06; G06F 2212/72

(57) ABSTRACT

Methods and systems, including computer-readable media, are described for reducing or preventing memory bank conflicts in a hardware accelerator to allow for concurrent access of memory banks at a hardware accelerator. A compute tile of the hardware accelerator receives requests that are used to access a tile memory of the accelerator. For each of the requests: a logical address represented by a sequence of bits is identified in the request and a first subset of bits is obtained from the sequence. An identifier is generated based on a bank generation function that uses the first subset of bits. The identifier identifies a particular bank among physical memory banks of the tile memory. Each request is processed using the respective bank identifier that is generated for that request. Multiple distinct memory banks are accessed concurrently during the same clock cycle in response to processing the requests.

### BACKGROUND

This specification generally relates to memory operations of a hardware integrated circuit.

Neural networks are machine-learning models that employ one or more layers of nodes to generate an output, e.g., a classification, for a received input. Some neural networks include one or more hidden layers in addition to an output layer. Some neural networks can be convolutional neural networks (CNNs) configured for image processing or recurrent neural networks (RNNs) configured for speech and language processing. Different types of neural network architectures can be used to perform a variety of tasks related to classification or pattern recognition, predictions that involve data modeling, and information clustering.

A neural network layer can have a corresponding set of parameters or weights.

The weights are used to process inputs (e.g., a batch of inputs) through the neural network layer to generate a corresponding output of the layer for computing a neural network inference. A batch of inputs and set of kernels can be represented as a tensor, i.e., a multi-dimensional array, of inputs and weights. A hardware accelerator is a special-purpose integrated circuit for implementing neural networks. The circuit includes memory with locations corresponding to elements of a tensor that may be traversed or accessed using control logic of the circuit.

### SUMMARY

This document describes techniques for reducing (or preventing) memory bank conflicts at tile memory of a hardware accelerator to allow for concurrent accesses of those physical memory banks.

A compute tile of the hardware accelerator receives requests that are used to access a tile memory of the accelerator. For each of the requests: i) a logical address represented by a sequence of bits is identified in the request; ii) a first subset of bits is obtained from the sequence; and iii) an identifier is generated based on a bank generation function that uses the first subset of bits.

The identifier identifies a particular bank among physical memory banks of the tile memory. Each request is processed using the respective bank identifier (“bank ID”) that is generated for that request. Multiple distinct memory banks are accessed concurrently during the same clock cycle (e.g., a single clock cycle) in response to processing the requests.

One aspect of the subject matter described in this specification can be embodied in a computer-implemented method for concurrently accessing memory banks of a hardware accelerator. The method includes receiving multiple requests, where each request is used to access a tile memory of the hardware accelerator. For each of the multiple requests the method includes: identifying, in the request, a respective logical address represented by a sequence of bits; obtaining a first subset of bits from the sequence of bits; and generating, based on a bank generation function that uses the first subset of bits, a respective bank identifier that identifies a particular bank among a plurality of physical memory banks of the tile memory. The method further includes: i) processing each of the multiple requests using the respective bank identifier that is generated for the request and ii) concurrently accessing, during a clock cycle, multiple distinct physical memory banks of the tile memory in response to processing each of the multiple requests.

These and other implementations can each optionally include one or more of the following features. For example, in some implementations, concurrently accessing the multiple distinct physical memory banks includes accessing, for a particular stride value, the multiple distinct physical memory banks during a single clock cycle. The particular stride value can be a memory access stride that is equal to a difference between particular rows of the same physical memory bank.

In some implementations, concurrently accessing the multiple distinct physical memory banks includes: accessing the multiple distinct physical memory banks without a bank conflict. In one aspect, the bank conflict is when two or more requesters request access to the same physical memory bank of the tile memory during the same clock cycle. Each physical memory bank can include multiple rows and the method includes: for each of the multiple requests: i) obtaining a second subset of bits from the sequence of bits; ii) providing the second subset of bits as an input to the bank generation function; and iii) based on the bank generation function being applied to the second subset of bits, generating a respective row identifier that identifies a particular row in the particular bank among the multiple physical memory banks of the tile memory.

In some implementations, each row of the multiple rows includes a width of 16 bytes; a partition of the tile memory includes 32 physical memory banks; and the memory access stride is equal to: row_width*num_banks. Obtaining a first subset of bits from the sequence of bits can include: obtaining two or more bits that are among the least significant bits (LSB) in the sequence of bits.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages. A bank generation function is disclosed that can be used to process multiple requests for memory resources of a tile memory without triggering a bank conflict.

The bank generation function is configured to generate a respective bank ID for each request in a group of requests, such that no two requests will require access to the same physical memory bank of the tile memory. The bank generation function provides an access pattern that allows for parallel processing of each request in the group during the same clock cycle (e.g., a single clock cycle). The access pattern provided by the bank generation function allows for concurrent processing of multiple requests irrespective of the stride value that is used for the memory accesses.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1A is a block diagram of an example computing system for implementing a neural network machine-learning model.

FIG. 1B is a block diagram of an example computing system for implementing a neural network machine-learning model.

FIG. 2 shows an example processing pipeline for routing inputs and outputs between a memory and compute cells of a hardware integrated circuit.

FIG. 3 shows examples of a memory traversal for different banking generation functions.

FIG. 4 shows an example bank generation function for reducing memory bank conflicts at a hardware integrated circuit.

FIG. 5 is an example process for reducing memory bank conflicts in a hardware integrated circuit.

FIG. 6 illustrates an example of an input tensor, a parameter tensor, and an output tensor.

Like reference numbers and designations in the various drawings indicate like elements.

### DETAILED DESCRIPTION

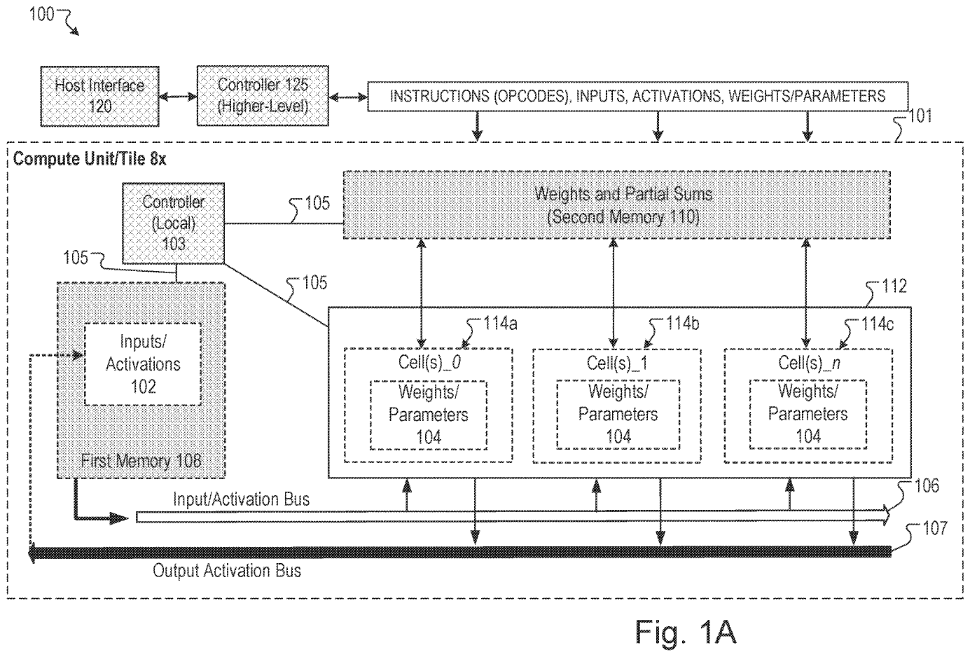

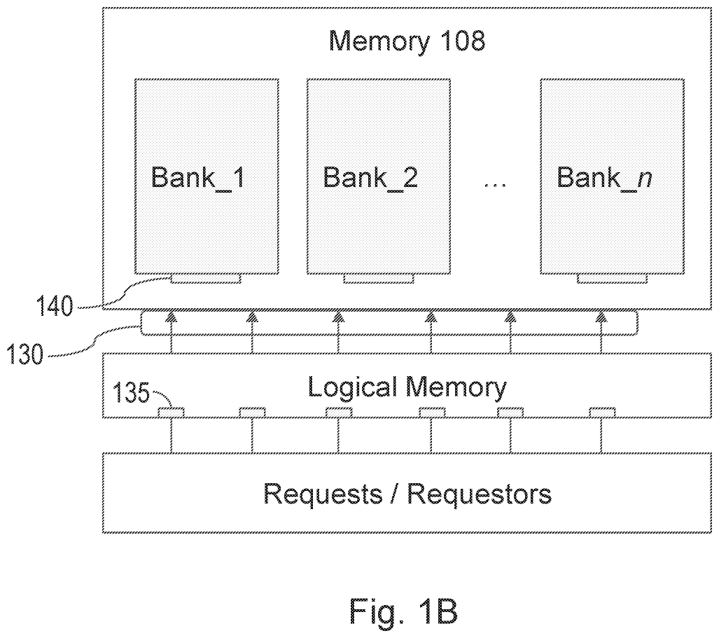

FIG. 1A is a block diagram of an example computing system 100 for implementing a neural network model at hardware integrated circuit, such as a machine-learning hardware accelerator. Compute system 100 includes one or more compute tiles 101, a host 120, and a higher-level controller 125 (“controller 125”). As described in more detail below, the host 120 and controller 125 cooperate to provide datasets and instructions to one or more compute tiles 101 of system 100.

In some implementations, the host 120 and the controller 125 are the same device. The host 120 and the controller 125 can also perform distinct functions but be integrated in a single device package. For example, the host 120 and controller 125 can form a central processing unit (CPU) that interacts or cooperates with a hardware accelerator, which includes the multiple compute tiles 101. In some implementations, the host 120, controller 125, and multiple compute tiles 101 are included or formed on a single integrated circuit die. For example, the host 120, controller 125, and multiple compute tiles 101 can form a special-purpose System-on-Chip (SoC) that is optimized for executing neural network models for processing machine-learning workloads.

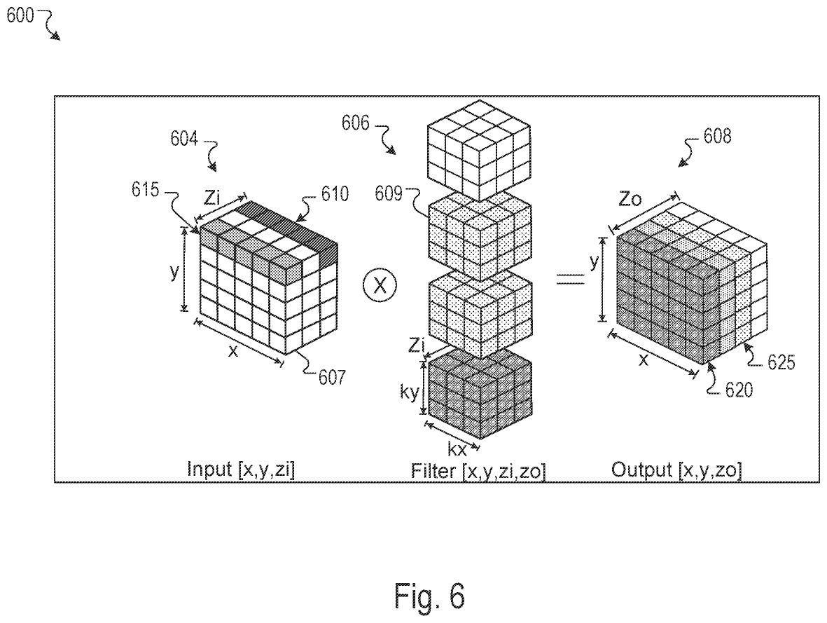

Each compute tile 101 generally includes a controller 103 that provides one or more control signals 105 to cause inputs (or activations) for an input vector 102 to be stored at, or accessed from, a memory location of a first memory 108 (“memory 108”). Likewise, the controller 103 can also provide one or more control signals 105 to cause weights (or parameters) for a matrix structure of weights 104 to be stored at, or accessed from, a memory location of a second memory 110 (“memory 110”). In some implementations, the input vector 102 is obtained from an input tensor, whereas the matrix structure of weights is obtained from a parameter tensor. Each of the input tensor and the parameter tensor may be multi-dimensional data structures, such as a multi-dimensional matrix or tensor. This is described in more detail below with reference to FIG. 6.

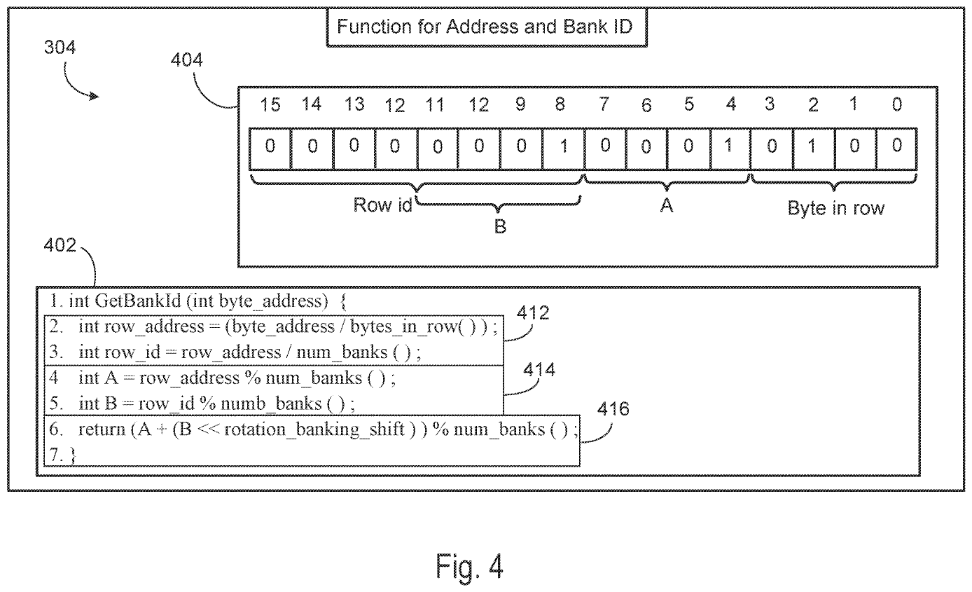

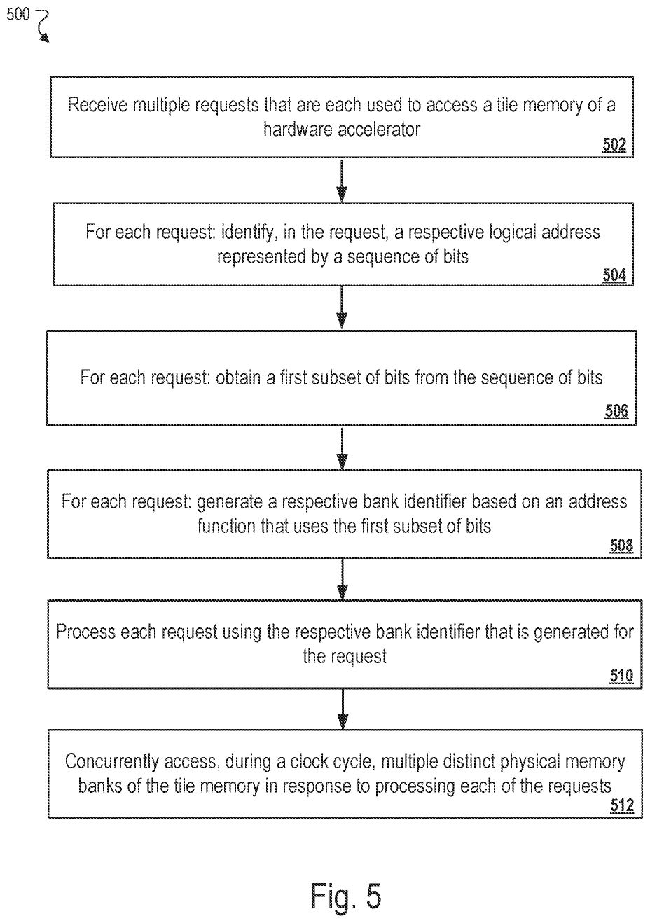

Each memory location of memory 108, 110 may be identified by a corresponding memory address, such as a logical address that has a corresponding mapping to a physical row of a physical memory bank of the memory. Referencing the example of FIG. 1B, a compute tile 101 may derive a set of contiguous addresses (e.g., virtual/logical addresses) from a group of requests 130. For example, the set of contiguous addresses can be derived with reference to a logical memory that corresponds to the physical memory 108 of the compute tile 101. This is also described below with reference to the embodiments of FIG. 4 and FIG. 5.

The logical memory has multiple logical ports 135 and each port can be connected to, or associated with, a different requestor that requests to access physical resources of the memory 108. To process a given access request, for each port, the tile 101 (or its controller 103) determines a bank to which the request will be routed based on an address in that request. For each bank, the compute tile 101 can include an arbiter 140 that arbitrates accesses from the multiple ports to that bank, for example, in accordance with a bank generation function that is uniquely configured to mitigate against some (or all) of the requests being routed to the same physical memory bank. The logical memory, ports of the logical memory, and the arbiters can be implemented in software, hardware, or both. In some implementations, the logical memory and its ports as well as the arbiters are controlled based on control signals generated by the controller 103.

Each of memory 108, 110 can be implemented as a series of physical banks, units, or any other related storage medium or device. Each of memory 108, 110 can include one or more registers, buffers, or both. In some implementations, memory 108 is an input/activation memory, whereas memory 110 is a parameter memory. In some other implementations, inputs or activations are stored at memory 108, memory 110, or both; and weights are stored at memory 110, memory 108, or both. For example, inputs and weights may be transferred between memory 108 and memory 110 to facilitate certain neural network computations. In some implementations, each of memory 108 and memory 110 are referred to as tile memory.

Each compute tile 101 also includes an input activation bus 106, an output activation bus 107, and a computational unit 112 that includes one or more hardware multiply accumulate circuits (MACs) in each cell 114 a/b/c. Controller 103 can generate control signals 105 to obtain operands stored at the memory of the compute tile 101. For example, controller 103 can generate control signals 105 to obtain: i) an example input vector 102 stored at memory 108 and ii) weights 104 stored at memory 110. Each input obtained from memory 108 is provided to input activation bus 106 for routing (e.g., direct routing) to a compute cell 114 a/b/c in the computational unit 112. Similarly, each weight obtained from memory 110 is routed to a cell 114 a/b/c of the computational unit 112.

As described below, each cell 114 a/b/c performs computations that produce partial sums or accumulated values for generating outputs for a given neural network layer. An activation function may be applied to a set of outputs to generate a set of output activations for the neural network layer. In some implementations, the outputs or output activations are routed for storage and/or transfer via output activation bus 107. For example, a set of output activations can be transferred from a first compute tile 101 to a second, different compute tile 101 for processing at the second compute tile 101 as input activations for a different layer of the neural network.

In general, each compute tile 101 and system 100 can include additional hardware structures to perform computations associated with multi-dimensional data structures such as tensors, matrices and/or data arrays. In some implementations, inputs for an input vector (or tensor) 102 and weights 104 for a parameter tensor can be pre-loaded into memory 108, 110 of the compute tile 101. The inputs and weights are received as sets of data values that arrive at a particular compute tile 101 from a host 120 (e.g., an external host), via a host interface, or from a higher-level control such as controller 125.

Each of compute tile 101 and controller 103 can include one or more processors, processing devices, and various types of memory. In some implementations, processors of compute tile 101 and controller 103 include one or more devices, such as microprocessors or central processing units (CPUs), graphics processing units (GPUs), application specific integrated circuits (ASICs), or a combination of different processors. Each of compute tile 101 and controller 103 can also include other computing and storage resources, such as buffers, registers, control circuitry, etc. These resources cooperate to provide additional processing options for performing one or more of the determinations and calculations described in this specification.

In some implementations, processing unit(s) of controller 103 executes programmed instructions stored in memory to cause controller 103 and compute tile 101 to perform one or more functions described in this specification. The memory of controller 103 can include one or more non-transitory machine-readable storage mediums. The non-transitory machine-readable storage medium can include solid-state memory, a random access memory (RAM), a read-only memory (ROM), an erasable programmable read-only memory (e.g., EPROM, EEPROM, or Flash memory), or any other tangible medium capable of storing information or instructions.

The system 100 receives instructions that define a particular compute operation to be performed by a compute tile 101. In some implementations, a host can generate sets of parameters (i.e., weights) and corresponding inputs for processing at a neural network layer. For example, a host can generate sets of compressed parameters (CSP) and corresponding mapping vectors, e.g., a non-zero map (NZM), that map an neural network input to a non-zero parameter in a set of CSPs for a given operation. The host 120 can send, via a host interface, the parameters to a compute tile 101 for further processing at the tile. The controller 103 can execute programmed instructions to analyze a data stream associated with the received weights and inputs, including the compressed parameters and corresponding mapping vectors.

The controller 103 causes inputs and weights of the data stream to be stored at the compute tile 101. For example, the controller 103 can store the mapping vectors and compressed sparse parameters in the local tile memory of the compute tile 101. This is described in more detail below. The controller 103 can also analyze the input data stream to detect an operation code (“opcode”). The system 100 can support various types of opcodes, such as opcode types that indicate operations for Vector-Matrix Multiplication, Elementwise Vector Operation and whether a given operation is using Compressed Sparse Parameters vs Uncompressed parameters/weights.

Based on one or more opcodes, the controller 103 can activate or execute a bank generation function (described below) to arbitrate requests for access to tile memory of a compute tile 101. For example, the controller 103 leverages the bank generation function to arbitrate two or more requests such that each of the two or more requests are processed against different physical banks of the tile memory. The controller 103 can employ a predetermined bank selection scheme that is programmed or encoded at the controller 103 before inference determinations are performed at the compute tile 101.

In some implementations, a given compute operation involves multiple requesters/accessors that each require access to resources of the memory 108. For example, a computational workload performed at compute tile 101 can trigger memory access requests due to tensor traversal operations that require read and write access to respective address locations of memory 108. As described below, these address locations can correspond to elements of an input tensor that is processed as part of the workload.

In addition to the tensor read/write operations, processing the workload can also involve processing read or write access requests to: i) move data (e.g., parameters) from memory 108 (narrow) to memory 110 (wide) and ii) move data from memory 110 (wide) to memory 108 (narrow). In some cases, to process an example workload, a first compute tile 101 arbitrates and executes access requests (e.g., read/write requests) for memory 108, where the requests are based on external data communications that originate from outside the first compute tile 101.

These different types of access requests correspond to one or more compute threads that all require access to the same physical memory 108. In some cases, multiple requests may correspond to a single compute thread (or clock cycle). The disclosed bank generation function can be used to process the multiple requests for memory resources of a tile memory without triggering a bank conflict. For example, the bank generation function is configured to generate a respective bank ID for each request in a group of requests, such that no two requests will require access to the same physical memory bank of the tile memory.

In some implementations, based on bank identifiers that are returned as outputs of the bank generation function, the controller 103 is able to arbitrate requests by processing two or more requests against different physical memory banks of tile memory during the same clock cycle (e.g., a single clock cycle). The bank generation function allows the controller 103 to realize these advantages even for certain problematic striding, such as memory accesses where the stride is a function of the number of banks and the number of bytes in a row of the banks. This is described in more detail below.

Additionally, based on the opcode, the controller 103 can activate special-purpose data path logic associated with one or more compute cells 114 a/b/c to perform computations (e.g., sparse computations) using the parameters and inputs/activations and corresponding mapping vectors that are used to map inputs/activations to a subset of parameters. As used in this document, sparse computations include neural network computations performed for a neural network layer using non-zero weight values in a set of compressed sparse parameters that are generated from a set of weights for the neural network layer.

In some implementations, the opcode indicates details about operations that pertain to inputs and weights for a given layer, such as sparsity of one or more parameter tensors associated with the layer. The controller 103: i) detects the opcode, including any related tensor sparsity information, ii) uses local read logic to obtain the parameters from tile memory (e.g., memory 108 or 110) based on the opcode, and iii) wires or routes those parameters to cells 114 a/b/c of the compute tile 101. The controller 103 can also analyze an example data stream and, based on that analysis, generate a set of compressed sparse parameters and a corresponding mapping vector that maps discrete inputs of an input vector to respective non-zero weight values in the compressed sparse parameters. To the extent operations and/or processes for generating the compressed sparse parameters and corresponding mapping vectors are described with reference to controller 103, each of those operations and processes can be also performed by host 120, controller 125, or both.

In some implementations, performing some (or all) of the operations at the host 120, such as analyzing tensors indices, performing direct memory access (DMA) operations to read address spaces in system memory (e.g., SRAM, DRAM, etc.) to obtain inputs and weight values, generating the compressed sparse parameters, and generating corresponding mapping vectors, allow for reductions in processing time at each compute tile 101 and for improving data throughput at the system 100. For example, performing these operations at the host 120 using controller 125 allows for sending an already compressed set of parameters to a given tile compute 101, which reduces the size and quantity of data that is routed at system 100.

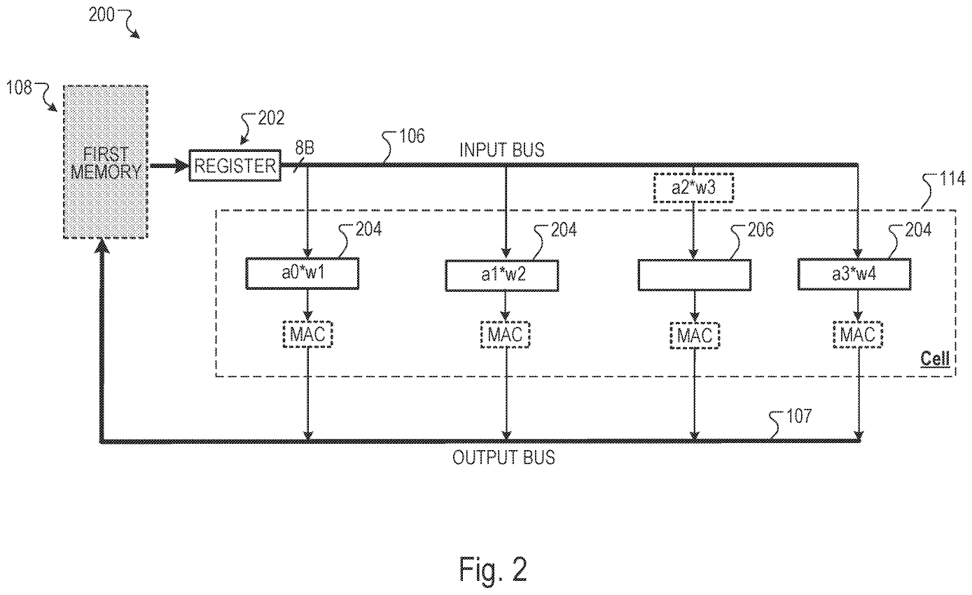

FIG. 2 shows an example processing pipeline 200 for routing inputs and outputs between a memory and compute cells of a hardware integrated circuit. In general, pipeline 200 uses the input bus 106 to route inputs obtained from a memory location of memory 108 to one or more compute cells 114 and uses the output bus 107 to route outputs generated from multiplication performed at the one or more compute cells 114 to a memory location of memory 108.

The pipeline 200 leverages a hardware architecture where the input bus 106 is coupled (e.g., directly coupled) to each of multiple groupings of hardware compute cells of special-purpose integrated circuit. The system 100 can provide a first operand from a location in memory 108 and a second operand from a location in memory 110. The operands 204 are used in computations performed at the cell 114 and cell 114 generates an output corresponding to a result of the computation. In some implementations, the computations are for a machine-learning operation, such as for processing inputs through a neural network layer of an artificial neural network.

In this implementation, a compute tile 101 can provide first operands corresponding to inputs or activations (e.g., a0, a1, a2, etc.) of an input feature map to a subset of cells 114. For example, a respective input of an input vector 102 is provided to each MAC in the subset via the input bus 106 of the compute tile 101. The system 100 can perform this broadcast operation across multiple compute tiles 101 to compute products for a given neural network layer using the respective groupings of inputs and corresponding weights at each compute tile 101. At a given compute tile 101, the products are computed by multiplying a respective input (e.g., a1) and corresponding weight (e.g., w1) at each MAC in the subset, using multiplication circuitry of the MAC.

The system 100 can generate an output for the layer based on an accumulation of multiple respective products that are computed at each MAC of a cell 114a/b/c in a subset of cells 114a/b/c of a compute unit 112. As explained below with reference to FIG. 6, the multiplication operations performed within a compute tile 101 can involve: i) a first operand (e.g., an input or activation) stored at a memory location of memory 108 that corresponds to a respective element of an input tensor and ii) a second operand (e.g., a weight) stored at a memory location of memory 110 that corresponds to a respective element of a parameter tensor.

In the example of FIG. 2, a shift register 202 can provide shift functionality in which an input of the operands 204 are broadcast onto the input bus 106 and routed to the one or more MACs of cell 114. In some implementations, the shift register 202 enables one or more input broadcast modes at a compute tile 101. For example, the shift register 202 can be used to broadcast inputs sequentially, e.g., one-by-one, from memory 108 (first broadcast mode), concurrently, e.g., in parallel, from memory 108 (second broadcast mode), or using some combination of these broadcast modes. The shift register 202 can be an integrated function of memory 108, and may be implemented in hardware, software, or both.

In some implementations, the weight (w3) of the operands 206 may have a weight value of zero. When the controller 103 determines that the weight (w3) has a zero value, to conserve processing resources, a multiplication between an input (a2) and the weight (w3) can be skipped, such that those operands are not routed to, or consumed by, a cell 114 a/b/c. The determination to skip that particular multiplication operation can be based on a mapping vector that maps discrete inputs (an) of an input vector to individual weights (wn) of a parameter tensor, as described above.

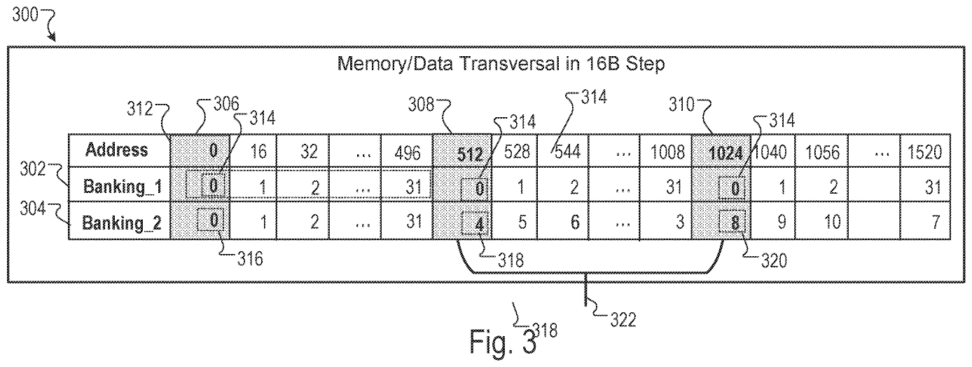

FIG. 3 illustrates a traversal table 300 that shows examples of memory/data traversal for different functions 302, 304 that are used to generate addresses for accessing physical memory banks of memory 108. In particular, a first memory traversal is shown for a first function 302, whereas a second, different memory traversal is shown for a second function 304. In some implementations, memory 108 includes one or more memory partitions.

In the example of FIG. 3, a partition of memory 108 includes 32 physical memory banks 312, which is shown as banks 0-31. Each bank can include some number of rows, e.g., 16, 24, etc. In some implementations, each row is 16 bytes (16 B) wide such that a compute tile 101 accesses data from memory 108 in 16 B chunks (e.g., 128-bits). In some implementations, memory 108 can include more or fewer physical memory banks and each row of a bank can have a width that is more than 16 B or less than 16 B (e.g., 1 B).

The traversal table 300 includes a first address 306, a second address 308, and a third address 310. The memory traversal distance between each of first address 306, second address 308, and third address 310 can be based on a stride value. In the example of FIG. 3, the stride value is 512. However, the stride value may be different in other examples. Thus, other stride values are within the scope of this disclosure. A stride operation may be required when the compute system 100 performs computations for a given task or machine-learning workload. The stride operation may be based on a stride parameter or value. A given stride value can be programmable at system 100. For example, the system 100 can program a stride for a given inference based on certain problematic strides that are known by a compiler of system 100 as being specific to a particular inference operation.

In some implementations, the stride values are determined based on a hardware configuration of the memory 108, the type of machine-learning operation being performed, or both. For example, the compute tiles 101 of system 100 can be used to implement a neural network that is tuned or used for compression, and/or recognition of images and video content (e.g., a Convolutional Neural Network). A stride may be a component of the neural network. In this example, the machine-learning operation involves processing images through a layer of the neural network in accordance with a filter corresponding to a set of weights/parameters for the layer.

The images, or pixel values associated with the images, can be stored across the physical rows and banks of memory 108, with reference to a hardware configuration of the physical rows and banks of the memory. In this example, a stride is a component or parameter of a filter (or kernel) of the neural network. The stride is used to modify an amount that the filter moves over an image or video. For example, when the stride is set to 1, then compute tile 101 moves the filter(s) over the region one pixel (or input) at a time. Likewise, when the stride is 2, then compute tile 101 moves the filter(s) over the region two pixels at a time.

Thus, filters may be shifted based on a stride value for a layer and, in some implementations, the system 100 can repeatedly perform this process across multiple compute tiles 101 for different layers until inputs for different regions of an image have a corresponding dot product. Moving a filter over inputs of a region of an image based on a stride value can include retrieving, obtaining, or otherwise accessing the inputs from various locations in memory 108 in accordance with that stride value.

As noted above, the images, or pixel values associated with the images, are stored across the physical rows and banks of memory 108. The example of FIG. 3 may be described with reference to a stride value of 512. In some examples, 512 represents a common stride associated with certain image processing operations. Depending on the type of operation, the compute tiles 101 of system 100 can process requests for accessing memory 108 in accordance with a range of stride values. For example, a first tile 101 may process requests based on a first stride value, where as a second, different tile 101 may process requests based on a second, different stride value.

As shown at traversal table 300, when bank generation function 302 is used to generate bank IDs for processing requests, an access stride of 512 repeats at the same physical memory bank 314 of the tile memory (e.g., bank 0). This indicates a bank conflict. As used in this document, a bank conflict occurs when two or more requesters request access to the same physical memory bank of the tile memory during the same clock cycle.

As described below with reference to FIG. 4, the bank generation function 304 is configured such that processing requests for access to physical rows in the memory banks of memory 108 consistently, or at least substantially, results in accessing distinct physical memory banks of memory 108. More specifically, for each request in a group of requests to access memory 108, the bank generation function 304 uses bits from an address in the request to generate a bank ID that results in accesses to different physical memory banks when the group of requests are processed in parallel, for example, during a single clock cycle.

For example, as shown at FIG. 3, the bank generation function 304 allows for processing two or more requests based on an access pattern that causes the compute tile 101 to access different physical memory banks of memory 108. The bank generation function 304 is configured to generate bank IDs and row IDs that allow for this access pattern irrespective of the stride value that is used for the memory accesses.

In some implementations, based on the bank IDs generated by the bank generation function 304: i) a first request causes the compute tile 101 to access 16B in a row of a first physical memory bank 316, e.g., bank “0”; ii) a second request causes the compute tile 101 to access 16B in a row of a second, different physical memory bank 318, e.g., bank “4”; and iii) a third request causes the compute tile 101 to access 16B in a row of a third, different physical memory bank 320, e.g., bank “8”.

Each of the first, second, and third requests can be different requests, can be from different requestors, or both. Based on the bank IDs and/or access pattern enabled by the bank generation function 304, there is either no instance or substantially no instance in which two or more requesters request access to the same physical memory bank of the tile memory during the same clock cycle. Thus, each of the first, second, and third requests can be processed concurrently during the same clock cycle (e.g., a single clock cycle) without occurrence of a bank conflict at the memory 108. Moreover, each of the first, second, and third requests can be processed concurrently during the same clock cycle (e.g., a single clock cycle) for a range of stride values (e.g., a stride of 512) without occurrence of a bank conflict.

In some implementations, the compute tile 101 is operable to route and store outputs such that memory 108 (e.g., an activation memory) does not experience a bank conflict when the stored output values are obtained as input activations to the second, different neural network layer. This is described in the following paragraphs with reference to activation values, but applies to other data types/values that may be written to (or stored at) physical locations of memory 108.

The compute tile 101 can include a non-linear unit that applies activation functions to accumulated values that result from the computations performed at the compute unit 112. In one example, the non-linear unit can be a hardware circuit that is included among the multiplication and addition circuits of the compute tile 101. In another example, the non-linear unit is included at the compute tile 101 but is external to the compute unit 112.

The non-linear unit applies its activation function to generate a set of activated values. The activated values can be outputs of a machine-learning workload. For example, the activated values may be outputs of a first neural network layer that are routed to, and stored at, a memory bank of memory 108. These activated values (e.g., outputs of a first layer) can be retrieved from memory banks of memory 108 and provided as input activations for processing through a second, different neural network layer.

The compute tile 101 can issue access requests (e.g., write access) to memory 108 to store outputs such as activation values at physical rows and banks of memory 108. In some examples, these requests can be routed to a partition of memory 108 that is used as an activation memory to store activations. In some implementations, these write access requests can be processed using bank generation function 304 such that system 100 does not experience a bank conflict at a particular compute tile 101 when the output/activation values are stored at memory 108 of that tile.

The bank generation function 304 can be also used to reduce or prevent bank conflicts when access requests (e.g., read access) are processed to retrieve or fetch the output values. For example, the output values can be fetched to be provided as input activations to the second, different neural network layer.

FIG. 4 shows an example bank generation function 304 for reducing memory bank conflicts at a hardware integrated circuit. As described above, the bank generation function 304 is configured such that requests for accessing physical rows in the memory banks of memory 108 consistently, or at least substantially, result in accessing distinct physical memory banks of memory 108.

For example, given a group of requests to access memory 108, a controller 103 of the compute tile 101 can derive a set of addresses from the group of requests. In some cases, the controller 103 may derive a set of contiguous addresses (e.g., virtual/logical addresses) from the group of requests. Given this set of contiguous addresses, the bank generation function 304 is configured to generate a corresponding set of bank identifiers (“bank IDs”).

For example, the bank generation function 304 generates a respective bank ID for each request in the group of requests.

The system 100, or a compute tile 101, can process the group of requests using the set of bank IDs over one or more clock cycles, or over the same clock cycle, without a bank conflict occurring at memory 108. Stated another way, based on the set of bank IDs generated by the bank generation function 304, a compute tile 101 can concurrently process (e.g., in parallel) each request in the group of requests and no two requests will require access to the same physical memory bank of the tile memory 108 during the same clock cycle.

In the example of FIG. 4, the bank generation function 304 generates a respective bank ID for each request based on an algorithm 402. The algorithm 402 generates a bank ID based on an example sequence of address bits 404 included in a corresponding request for access to memory 108. For example, the compute tile 101 uses the sequence of address bits 404 to obtain a respective value for one or more variables that are provided as inputs to the algorithm 402. The input variables can correspond to different portions of the sequence of address bits 404.

A first variable, A, may be obtained from a first portion of bits, a second variable, B, may be obtained from a second portion of bits, a third variable, row_id, may be obtained from a third portion of bits, and a fourth variable, byte_in_row, may be obtained from a fourth portion of bits. For example, the sequence of bits 404 can be an input address that is split into two parts: i) bytes_in_row (number of bytes in memory row) and ii) a row_address. Using the bank generation function 304, the row_address can be split into two parts: i) a row_id (e.g., row_id in each bank) and ii) a conventional bank id that is defined as variable A. The least significant bits (LSBs) of the row_id may be defined as variable B.

As indicated in the example of FIG. 4, for a given bit sequence 404, one or more bits in one portion of the sequence 404 may overlap with one or more bits in another portion of the sequence. In some implementations, an input variable can correspond to the least significant bits (lsb) in a request or the most significant bits (msb) in a request.

In some implementations, the bank generation function 304 is configured to perform at least a first set of operations 412, a second set of operations 414, and a third operation 416. The first and/or second set of operations can be used to establish certain input variables, such as row_address, row_id, A, and B. In some cases, row_address is used to extract certain bits in the sequence 404, such as bits 4-15, whereas row_id is used to extract certain other bits, such as bits 8-15. In some implementations, the variables may be used to extract other ranges or combinations of bits.

The third operation (or set of operations) 416 can be used to rotate a bit vector based on a shift parameter or operation, such as rotation_banking_shift. The bit vector may be derived from a sequence of address bits in a request for access to memory 108 based on operations performed using the bank generation function 304. The bit vector may be derived from the msb in the sequence of address bits or the lsb in the sequence of address bits. For example, the bit vector may be a combination of variables A and B and the bank generation function 304 is configured to apply a rotation_banking_shift operation on this combination of variables.

The rotation_banking_shift operation can be applied with reference to a number of banks in the memory of a compute tile 101. For example, the rotation_banking_shift operation can be used to: i) shift a msb bit vector by an amount specified by a shift value of the operation or ii) shift a lsb bit vector by an amount specified by a shift value of the operation. The system 100 performs the shift operation so that a bank ID for a new bank will belong to a particular group. Accordingly, the third operation 416 can produce a rotated bank ID in accordance with the number of banks as well as any row, bank, and byte attributes associated with variables A and/or B.

In some implementations, the system 100 determines a minimum number of bits for defining the msb or the lsb. For example, the system 100 can determine the minimum number of bits based on the quantity of physical memory banks in a given partition of memory 108. For example, if there are 32 physical memory banks then the system 100 can determine that a minimum number of 5 bits is required to represent 32 numbers or 32 row IDs.

In some implementations, the bank generation function 304 is configured or coded as shown at algorithm 402 in the example of FIG. 4. In some other implementations, a modified bank generation function can be configured or coded (using alternative commands) to generate a set of bank IDs that can be processed concurrently at a compute tile 101, without triggering a bank conflict at memory 108. For example, this modified bank generation function can be configured or coded for a tile memory that includes more or fewer physical memory banks and more or fewer rows, relative to memory 108.

The bank generation function 304 can be an algorithm that receives one or more inputs and generates one or more outputs. For example, as discussed above, the inputs can be a respective address for one or more rows (“row_address”), the number of rows in each bank (“rows_per_bank”), the least significant bits (lsb) in a request, a minimum quantity of bits for lsb, the most significant bits (msb) in a request, a minimum quantity of bits for msb, a bank rotation parameter, or a shift parameter (“msb_shift_minus_1”). The outputs can be respective bank IDs for physical memory banks of memory 108 and respective row IDs for physical rows in a physical memory bank of memory 108. More or fewer inputs are within the scope of this disclosure and may be used to in connection with the bank generation function 304.

FIG. 5 is an example process 500 for reducing memory bank conflicts in a tile memory of a hardware accelerator or special-purpose hardware integrated circuit. In some implementations, process 500 is performed during computations for a neural network machine-learning model implemented on a hardware accelerator. For example, the computations can be performed to process a neural network input, such as an image or speech utterance, using a special-purpose neural network processor. Such a processor may be represented by the integrated circuit or system 100 described with reference to FIG. 1A.

For example, the hardware integrated circuit can be configured to implement a CNN that includes multiple neural network layers. In some cases, the neural network layers can include a group convolution layer. The input may be an example image as described above, including various other types of digital images or related graphical data. In at least one example, the integrated circuit can implement a RNN for processing inputs derived from an utterance or other audio content. In some cases, process 500 is part of a technique that, relative to other data processing techniques, allows for realizing improvements in latency and throughput when accelerating neural network computations to generate image or speech processing outputs.

Process 500 can be implemented or executed using the system 100 described above. Hence, descriptions of process 500 may reference the above-mentioned computing resources of system 100. In some examples, the steps or actions of process 500 are enabled by programmed firmware instructions, software instructions, or both. Each type of instruction may be stored in a non-transitory machine-readable storage device and is executable by one or more processors of the devices and resources described in this document.

In some implementations, the steps of process 500 are performed at a hardware circuit to generate a layer output for a neural network layer. The output can be a portion of computation for a machine-learning task or inference workload to generate an image processing or image recognition output. As indicated above, the integrated circuit can be a special-purpose neural network processor or hardware machine-learning accelerator configured to accelerate computations for generating various types of data processing outputs.

Referring again to process 500, system 100 receives multiple requests for access to memory resource of the system (502). For example, each request of the multiple requests can be used to access a first, tile memory of an integrated circuit or hardware accelerator. In some implementations, the system 100 processes multiple requests across multiple tiles. For example, the system 100 can process a respective subset of requests at each compute tile 101 of an integrated circuit.

For each request, the system 100 can identify a respective logical address represented by a sequence of bits in the request (504). As described above, memory 108 can be row-addressable, such that a row of a memory bank can be identified or accessed based on an address in a corresponding request. In general, each request specifies a logical address that can be mapped to a corresponding physical address. For example, a compiler of the system 100 can determine a mapping for a set of logical addresses to a corresponding set of physical addresses, where the physical address specifies a physical location in memory, such as a location of a bank in first memory 108 or a location of a row in a bank in first memory 108.

For each request, the system 100 can obtain a first subset of bits from the sequence of bits (506). For example, the logical address can be specified by a data structure that includes a sequence of bits, e.g., 8-bits, 16-bits, etc. In some implementations, a controller 103 of a compute tile 101 scans each data structure representing a logical address that is specified by a request. In response to scanning the bits that form the data structure the controller identifies or determines a subset of bits that can be used as inputs to a bank generation function. In some implementations, the controller determines the subset of bits based on a configuration of the tile memory 108.

For each request, the system 100 can generate a respective bank identifier (“bank ID”) based on a bank generation function 304 that uses the first subset of bits (508). Each respective bank ID identifies a particular physical bank among the multiple physical memory banks of memory 108. As described above, each physical memory bank can include multiple rows. For each request, the compute tile 101 can: i) obtain a second subset of bits from the sequence of bits; ii) provide the second subset of bits as an input to the bank generation function; and iii) based on the bank generation function being applied to the second subset of bits, generate a respective row ID that identifies a particular row in the particular bank among the physical memory banks of the tile memory.

System 100 is configured to process each request using the respective bank ID that is generated for the request (510). In some implementations, a compute tile 101 processes multiple requests (e.g., in concurrently) and, in response to processing the requests, accesses two or more physical memory banks in parallel without occurrence of a bank conflict (512). For example, a controller 103 of the compute tile 101 generates control signals to access a physical bank or row of memory 108 to retrieve an input vector 102 from address locations of the first memory 108.

In some implementations, the compute tile 101 can concurrently access multiple distinct physical memory banks of the tile memory during a single clock cycle in response to processing each of the requests to retrieve one or more input vectors. The input vector 102 can correspond to an input feature map of an image and may be a matrix structure of neural network inputs, such as activations generated by a previous neural network layer.

As discussed above, the bank generation function 304 allows for processing two or more requests based on an access pattern that causes the compute tile 101 to access different physical memory banks of memory 108. The bank generation function 304 is configured to generate bank IDs and row IDs that allow for this access pattern irrespective of the stride value that is used for the memory accesses.

Notably, the bank generation function can provide for this access pattern even when a memory access stride is equal to a difference between particular rows of the same physical memory bank. For example, each row of a physical memory bank can have a width of 16 bytes and a partition of the tile memory can have 32 physical memory banks. In this example, the bank generation function can provide for this access pattern even when the memory access stride is equal to: row_width*num_banks (i.e., stride=512).

FIG. 6 illustrates examples of tensors or multi-dimensional matrices 600 that include an input tensor 604, variations of a parameter tensor 606, and an output tensor 608.

In the example of FIG. 6, each of the tensors 600 include respective elements, where each element can correspond to a respective data value (or operand) for computations performed at a given layer of a neural network.

For example, each input of input tensor 604 can correspond to a respective element along a given dimension of input tensor 604, each weight of parameter tensor 606 can correspond to a respective element along a given dimension of the parameter tensor 606, and each output value or activation in a set of outputs can correspond to a respective element along a given dimension of output tensor 608. Relatedly, each element can correspond to a respective memory location or address in a memory of a compute tile 101 that is assigned to operate on one or more dimensions of a given tensor 604, 606, 608.

The computations performed at a given neural network layer can include multiplication of an input/activation tensor 604 with a parameter/weight tensor 606 on one or more processor clock cycles to produce layer outputs, which may include output activations. Multiplying an activation tensor 604 with a weight tensor 606 includes multiplying an activation from an element of tensor 604 with a weight from an element of tensor 606 to produce one or more partial sums. The example tensors 606 of FIG. 6 can be unmodified parameter tensors, modified parameter tensors, or combination of these. In some implementations, each parameter tensor 606 corresponds to a modified parameter tensor that includes non-zero CSP values that are derived based on certain sparsity exploitation techniques.

The processor cores of system 100 can operate on: i) scalars that correspond to a discrete element in some multi-dimensional tensor 604, 606; ii) a vector of values (e.g., input vector 102) that include multiple discrete elements 609 along the same or different dimensions of some multi-dimensional tensor 604, 606; or iii) a combination of these. The discrete element 609, or each of the multiple discrete elements 609, in some multi-dimensional tensor can be represented using X, Y coordinates (2D) or using X, Y, Z coordinates (3D) depending on the dimensionality of the tensor.

The system 100 can compute multiple partial sums that correspond to products generated from multiplying a batch inputs with corresponding weight values. As noted above, the system 100 can perform an accumulation of products (e.g., partial sums) over many clock cycles. For example, the accumulation of products can be performed in a random access memory, shared memory, or scratchpad memory of one or more compute tiles based on the techniques described in this document. In some implementations, an input-weight multiplication may be written as a sum-of-product of each weight element multiplied with discrete inputs of an input vector 102, such as a row or slice of the input tensor 604. This row or slice can represent a given dimension, such as a first dimension 610 of the input tensor 604 or a second, different dimension 615 of the input tensor 604.

In some implementations, an example set of computations can be used to compute an output for a convolutional neural network layer. The computations for the CNN layer can involve performing a 2D spatial convolution between a 3D input tensor 604 and at least one 3D filter (weight tensor 606). For example, convolving one 3D filter 606 over the 3D input tensor 604 can produce a 2D spatial plane 620 or 625. The computations can involve computing sums of dot products for a particular dimension of an input volume that includes the input vector 102.

For example, the spatial plane 620 can include output values for sums of products computed from inputs along dimension 610, whereas the spatial plane 625 can include output values for sums of products computed from inputs along dimension 615. The computations to generate the sums of the products for the output values in each of spatial planes 620 and 625 can be performed: i) at the compute cells 114 a/b/c, ii) directly at the memory 110 using an arithmetic operator coupled to a shared bank of the memory 110, iii) or both. In some implementations, reduction operations may be streamlined and performed directly at a memory cell (or location) of memory 110 using various techniques for reduction of accumulated values.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus.

Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read-only memory or a random access memory or both. Some elements of a computer are a central processing unit for performing or executing instructions and one or more memory devices for storing instructions and data. Generally, a computer will also include, or be operatively coupled to, receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network.

Examples of communication networks include a local area network (“LAN”) and a wide area network (“WAN”), e.g., the Internet.

The computing system can include clients and servers. A client and server are generally remote from each other and typically interact through a communication network.

The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments, separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method for concurrently accessing memory banks of a hardware accelerator, the method comprising:
receiving a plurality of requests, each of the plurality of requests being used to access a tile memory of the hardware accelerator;
for each of the plurality of requests:
identifying, in the request, a respective logical address represented by a sequence of bits;
obtaining a first subset of bits from the sequence of bits; and
generating, based on a bank generation function that uses the first subset of bits, a respective bank identifier that identifies a particular bank among a plurality of physical memory banks of the tile memory;
processing each of the plurality of requests using the respective bank identifier that is generated for the request; and
concurrently accessing, during a clock cycle, multiple distinct physical memory banks of the tile memory in response to processing each of the plurality of requests.

2. The method of claim 1, wherein concurrently accessing the multiple distinct physical memory banks comprises:
accessing, for a particular stride value, the multiple distinct physical memory banks during a single clock cycle.

3. The method of claim 2, wherein the particular stride value is a memory access stride that is equal to a difference between particular rows of the same physical memory bank.

4. The method of claim 3, wherein concurrently accessing the multiple distinct physical memory banks comprises:
accessing the multiple distinct physical memory banks without a bank conflict.

5. The method of claim 4, wherein a bank conflict is when two or more requesters request access to the same physical memory bank of the tile memory during the same clock cycle.

6. The method of claim 5, wherein each physical memory bank comprises a plurality of rows and the method comprises:
for each of the plurality of requests:
obtaining a second subset of bits from the sequence of bits;
providing the second subset of bits as an input to the bank generation function; and
based on the bank generation function being applied to the second subset of bits, generating a respective row identifier that identifies a particular row in the particular bank among the plurality of physical memory banks of the tile memory.

7. The method of claim 6, wherein:
each row of the plurality of rows comprises a width of 16 bytes;
a partition of the tile memory comprises 32 physical memory banks; and
the memory access stride is equal to: row_width*num_banks.

8. The method of claim 1, wherein obtaining a first subset of bits from the sequence of bits comprises:
obtaining two or more bits that are among the least significant bits (LSB) in the sequence of bits.

9. A system comprising:
a hardware accelerator;
a processing device; and
a non-transitory machine-readable storage medium for storing instructions that are executable by the processing device to cause performance of operations comprising:
receiving a plurality of requests, each of the plurality of requests being used to access a tile memory of the hardware accelerator;
for each of the plurality of requests:
identifying, in the request, a respective logical address represented by a sequence of bits;
obtaining a first subset of bits from the sequence of bits; and
generating, based on a bank generation function that uses the first subset of bits, a respective bank identifier that identifies a particular bank among a plurality of physical memory banks of the tile memory;
processing each of the plurality of requests using the respective bank identifier that is generated for the request; and
concurrently accessing, during a single clock cycle, multiple distinct physical memory banks of the tile memory in response to processing each of the plurality of requests.

10. The system of claim 9, wherein concurrently accessing the multiple distinct physical memory banks comprises:
accessing, for a particular stride value, the multiple distinct physical memory banks during a single clock cycle.

11. The system of claim 10, wherein the particular stride value is a memory access stride that is equal to a difference between particular rows of the same physical memory bank.

12. The system of claim 11, wherein concurrently accessing the multiple distinct physical memory banks comprises:
accessing the multiple distinct physical memory banks without a bank conflict.

13. The system of claim 12, wherein a bank conflict is when two or more requesters request access to the same physical memory bank of the tile memory during the same clock cycle.

14. The system of claim 13, wherein each physical memory bank comprises a plurality of rows and the operations further comprise:
for each of the plurality of requests:
obtaining a second subset of bits from the sequence of bits;
providing the second subset of bits as an input to the bank generation function; and
based on the bank generation function being applied to the second subset of bits, generating a respective row identifier that identifies a particular row in the particular bank among the plurality of physical memory banks of the tile memory.

15. The system of claim 14, wherein:
each row of the plurality of rows comprises a width of 16 bytes;
a partition of the tile memory comprises 32 physical memory banks; and
the memory access stride is equal to: row_width*num_banks.

16. The system of claim 9, wherein obtaining a first subset of bits from the sequence of bits comprises:
obtaining two or more bits that are among the least significant bits (LSB) in the sequence of bits.

17. A non-transitory machine-readable storage medium for storing instructions that are executable by a processing device of a hardware accelerator to cause performance of operations comprising:
receiving a plurality of requests, each of the plurality of requests being used to access a tile memory of the hardware accelerator;
for each of the plurality of requests:
identifying, in the request, a respective logical address represented by a sequence of bits;
obtaining a first subset of bits from the sequence of bits; and
generating, based on a bank generation function that uses the first subset of bits, a respective bank identifier that identifies a particular bank among a plurality of physical memory banks of the tile memory;
processing each of the plurality of requests using the respective bank identifier that is generated for the request; and
concurrently accessing, during a single clock cycle, multiple distinct physical memory banks of the tile memory in response to processing each of the plurality of requests.

18. The non-transitory machine-readable storage medium of claim 17, wherein concurrently accessing the multiple distinct physical memory banks comprises:
accessing, for a particular stride value, the multiple distinct physical memory banks during a single clock cycle.

19. The non-transitory machine-readable storage medium of claim 18, wherein the particular stride value is a memory access stride that is equal to a difference between particular rows of the same physical memory bank.

20. The non-transitory machine-readable storage medium of claim 19, wherein concurrently accessing the multiple distinct physical memory banks comprises:
accessing the multiple distinct physical memory banks without a bank conflict.
